(19) United States
(12) Patent Application Publication
(10) Pub. No.: US 2019/0266666 A1
(43) Pub. Date: Aug. 29, 2019

(54) VEHICLE MANAGEMENT DEVICE, VEHICLE MANAGEMENT METHOD, AND NON-TRANSITORY COMPUTER-READABLE MEDIUM

(71) Applicant: Toyota Jidosha Kabushiki Kaisha, Toyota-shi Aichi-ken (JP)

(72) Inventors: Kazuhiro Umeda, Nisshin-shi Aichi-ken (JP); Takumi Fukunaga, Nisshin-shi Aichi-ken (JP); Makoto Akahane, Nagoya-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/283,045

(22) Filed: Feb. 22, 2019

(30) Foreign Application Priority Data
Feb. 26, 2018 (JP) 2018-032022

(51) Int. Cl. G06Q 30/06; G06Q 10/02; G06Q 20/14

(52) U.S. Cl. CPC G06Q 30/0645; G06Q 20/14; G06Q 10/02

(57) ABSTRACT

A vehicle management device includes a processor. The processor is configured to analyze a use status of a vehicle, available in a car sharing service for a predetermined time range with respect to each rental place to rent the vehicle based on use record information for the vehicle and change a use fee for the predetermined time range based on the analyzed use status.

### CROSS-REFERENCE TO RELATED APPLICATION

This application claims priority to Japanese Patent Application No. 2018-032022 filed on Feb. 26, 2018, incorporated herein by reference in its entirety.

### BACKGROUND

### 1. Technical Field

The disclosure relates to a vehicle management device, a vehicle management method, and a non-transitory computer-readable medium in which a program that allows a computer to execute processing is stored.

### 2. Description of Related Art

Japanese Patent Application Publication No. 2013-54537 (JP 2013-54537 A) describes a vehicle management system that, when a user makes a reservation to use a vehicle available for car sharing services, refers to past use characteristic information of the user and suggests the user to change the reservation to a date and time where the vehicle is available and the user is allowed to use the car sharing services at a lower fee than normal.

### SUMMARY

JP 2013-54537 A focuses on a rental date and time with a low reservation rate, and a use fee for a rental date and time with the low reservation rate is reduced in an effort to increase an operation rate of vehicles. However, focusing on the rental date and time is not enough to increase the operation rate and there is room for improvement.

The disclosure provides a vehicle management device, a vehicle management method, and a non-transitory computer-readable medium in which a program that allows a computer to execute processing is stored that can promote an increase in the operation rate of the vehicles available in a car sharing service.

The vehicle management device according to a first aspect of the disclosure includes a processor. The processor is configured to analyze a use status of a vehicle available in a car sharing service for a predetermined time range with respect to each rental place to rent the vehicle based on use record information for the vehicle and change a use fee for the predetermined time range based on the analyzed use status.

In the aspect described above, the processor may further be configured to receive a fee confirmation request including a scheduled rental place and a scheduled rental date and time input by a user, specify the use fee corresponding to the scheduled rental place and the scheduled rental date and time based on the fee confirmation request, and provide the user with the specified use fee.

In the aspect described above, the processor may further be configured to select a use fee smaller than the use fee corresponding to the scheduled rental place and the scheduled rental date and time, out of the use fees corresponding to the rental place within a predetermined distance from the scheduled rental place and a rental date and time within a predetermined period including the scheduled date and time based on the fee confirmation request, generate recommended information based on the rental place and rental date and time corresponding to the selected smaller use fee, and provide the user with the generated recommended information.

In the aspect described above, the processor may be configured to receive the confirmation request further including a current location of the user and select the use fee smaller than the use fee corresponding to the scheduled rental place and the scheduled rental date and time, out of the use fees corresponding to the rental place within the predetermined distance from the scheduled rental place and the rental date, and time within the predetermined period including the scheduled date and time based on the fee confirmation request further including the current location of the user.

In the aspect described above, the processor may be configured to analyze the use status of the vehicle for a day of a week and the predetermined time range with respect to each rental place to rent the vehicle.

In the aspect described above, the processor may be configured to calculate a transition in the number of non-operating vehicles as the use status.

In the aspect described above, the processor may he configured to set a larger fee for a time range with a smaller number of non-operating vehicles than a fee set for a time range with a larger number of non-operating vehicles.

A second aspect of the disclosure relates to a vehicle management method executed by a processor. The method includes analyzing a use status of a vehicle available in a car sharing service for a predetermined time range with respect to each rental place to rent the vehicle based on use record information for the vehicle and changing a use fee for the predetermined time range based on the analyzed use status.

A third aspect of the disclosure relates to a non-transitory computer-readable medium storing a program that allows a computer to execute processing. The processing includes analyzing a use status of a vehicle available in a car sharing service for a predetermined time range with respect to each rental place to rent the vehicle based on use record information for the vehicle and changing a use fee for the predetermined time range based on the analyzed use status.

According to the aspects of the disclosure, a vehicle management device, a vehicle management method, and a non-transitory computer-readable medium in which a program that allows a computer to execute processing, is stored that can promote the increase in the operation rate of the vehicles available in car sharing services can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of a vehicle management system including a server according to an embodiment;

FIG. 2 is a table describing an example of a fee table;

FIG. 3 is a flowchart describing an example of an operation in which a use status of a vehicle is analyzed and a use fee is changed; and

FIG. 4 is a flowchart describing an example of an operation in which the use fee and recommended information is provided to a user based on a fee confirmation request.

### DETAILED DESCRIPTION

An embodiment of the present disclosure will be described below with reference to the accompanying drawings. In the respective drawings, units denoted with the same reference numerals have the same or similar configuration,

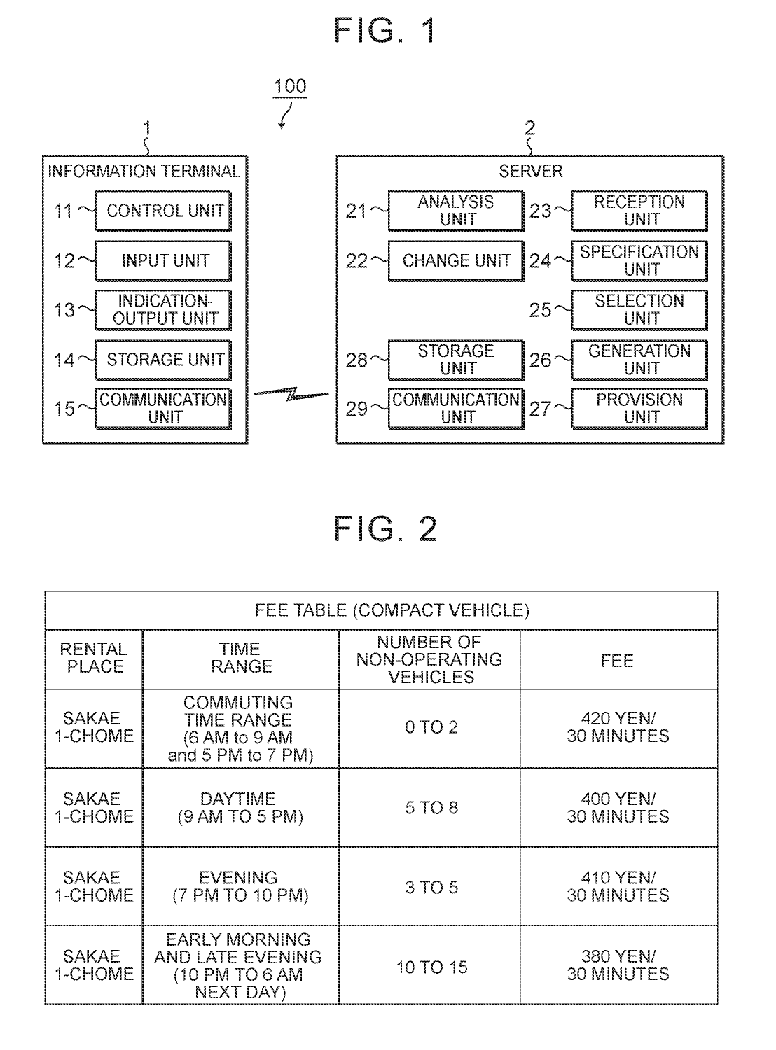

A configuration of a vehicle management system including a vehicle management device according to an embodiment will be described with reference to FIG. 1. A vehicle management system 100 includes, for example, an information terminal 1 kept by a user using a car sharing service and a server (vehicle management device) 2 for managing vehicles available in the car sharing service. The information terminal 1 and the server 2 are configured to be communicable with each other via a network including a wireless network, for example.

The information terminal 1 illustrated in FIG. 1 is a terminal device such as a smartphone. The information terminal 1 is not limited to a smartphone. For example, a tablet terminal, a portable information terminal, a laptop computer, a personal computer (PC), and other terminal devices may be used appropriately as the information terminal 1.

The information terminal 1 includes, for example, a control unit 11, an input unit 12, an indication-output unit 13, a storage unit 14, and a communication unit 15 as a functional configuration. The information terminal 1 includes, for example, a controller including a central processing unit (CPU) and a memory, an operation device, a display, a speaker, a storage device, and a communication device as a physical configuration. Respective functions of the control unit 11, the input unit 12, the indication-output unit 13, the storage unit 14, and the; communication unit 15 are realized by the CPU executing the predetermined program stored in the memory.

The server 2 includes, for example, an analysis unit 21, a change unit 22, a reception unit 23, a specification unit 21, a selection unit 25, a generation unit 26, a provision unit 27, a storage unit 28, and a communication unit 29 as a functional configuration. The server 2 includes, for example, a controller including a CPU and a memory, a storage device, and a communication device as a physical configuration. Respective functions of the analysis unit 21, the change unit 22, the reception unit 23, the specification unit 24, the selection unit 25, the generation unit 26, the provision unit 27, the storage unit 28, and the communication unit 29 are realized by the CPU executing the predetermined program stored in the memory.

The server 2 stores and manages vehicle info motion of respective vehicles available in car sharing services via a database, for example. The vehicle information includes, for example, a vehicle ID that identifies the vehicle and use record information fur the vehicle. The rise record information for the vehicle includes, for example, a user ID that identifies the user using the vehicle, a use start time, a use start place, a return date and time, and a return place.

The use record information for tie vehicle can be collected as needed from an on-board device mounted on respective vehicles and the information terminal 1 kept by the user using respective vehicles, for example. A part of or all of the use record information for the vehicle may be collected as needed from a server of a data center that manages information including information of the on-board device, rather than from the on-board device itself.

The analysis unit 21, the change unit 22, the reception unit 23, the specification unit 24, the selection unit 25, the generation unit 26, and the provision unit 27 of the functions of the server 2 are described in detail below.

The analysis unit 21 analyzes a use status of the vehicle for a predetermined time range with respect to each rental place to rent the vehicle based on the use record information for the vehicles available in the car sharing services. The analysis is, repeatedly executed at predetermined intervals that can be set as desired. As the use status of the vehicle, for example, a transition in the number of vehicles not in operation (hereinafter referred to as “non-operating vehicles”) in the rental place can be used.

The predetermined time range, for analyzing the use status nun be defined as, for example, slices of one hour or two hours, or may be as a desired time range such as a commuting time range (from 6 a.m. to 9 a.m. and from 5 p.m. to 7 p.m., etc.), daytime (from 9 a.m. to 5 p.m., etc.), evening (from 7 p.m. to 10 p.m., etc.) and early day and late evening (from 10 p.m. to 6 a.m. next day, etc.).

The use status of the vehicle nun be analyzed only for the predetermined time range, but may also be analyzed for both a day of the week and the predetermined time range, for example. For example, the day of the week may be defined by each day of the week and may also be defined by a group of the days of the week that is set as desired such as weekdays and weekends and holidays.

The change unit 22 changes a use fee for the predetermined time range (for example, commuting time range, daytime, evening, and early day and late evening) based on the analyzed use status (for example, the number of non-operating vehicles). The use fee will be described in detail below with reference to a fee table for compact vehicles exemplified in FIG. 2.

FIG. 2 is an example of the fee table for compact vehicles rented at a parking lot in “Sakae 1-Chome”. The number of non-operating vehicles in the fee table represents the number of non-operating vehicles calculated by the analysis unit 21 through analysis of, the use record information for the vehicles, and indicates the smallest number and largest number of vehicles within the number of vehicles transitioning in the relevant time range.

The fees in the fee table represents the use fees to be added every 30 minutes. The fee for the “commuting time range” in which the number of non-operating vehicles is the smallest (zero to two vehicles) is changed by the change unit 22 to the largest fee (420 yen/30 minutes).

Similarly, the fee in the “evening” in which the number of non-operating vehicles is the second smallest (three to five vehicles) is changed by the change unit 22 to the second largest fee (410 yen/30 minutes). The fee in the “daytime” in which the number of non-operating vehicles is the third smallest (five to eight vehicles) is changed by the change unit 22 to the third largest fee (400 yen/30 minutes). The fee in the “early day and late evening” in which the number of non-operating vehicles is the largest (10 to 15 vehicles) is changed by the change unit 22 to the smallest fee (380 yen/30 minutes).

Hence, by changing the use fee according to the analyzed past number of non-operating vehicles, a larger fee can be set to a time range with a smaller number of non-operating vehicles and a smaller fee can be set to a time range with a larger number of non-operating vehicles. The operation rate of vehicles that varies depending on the time range can thus be smoothed, enabling improvement in the overall operation rate.

The reception unit 23 illustrated in FIG. 1 receives from the information terminal 1 a fee confirmation request including a scheduled rental place and a scheduled rental date and time input by the user. Specifically, when the user operates the information terminal 1 to set the desired rental place and rental date and time as the scheduled rental place and the scheduled date and time, respectively and finalizes the setting for fee confirmation, the fee confirmation request is sent from the information terminal 1 to the server

The specification unit 24 specifies the use fee corresponding to the scheduled rental place and the scheduled rental date and time based on the fee confirmation request received from the information terminal 1. When specifically described with reference to FIG. 2, in the case where the scheduled rental place is a parking lot in “Sakae 1-Chome,” and the scheduled rental time is “7 a.m.,” the specification unit 24 specifies “420 yen/30 minutes” gas the use fee.

Based on the fee confirmation request received from the information terminal 1, the selection unit 25 selects a use fee smaller than the use fee corresponding to the scheduled rental place and the scheduled rental date and time, out of the use fees corresponding to rental places thin a predetermined distance from the scheduled rental place and rental dates and times within a predetermined period including the scheduled date and time.

The predetermined distance from the scheduled rental place can he set as desired to a distance within a radius of 500 m from the scheduled rental place or a distance within a radius, of 800 m from the scheduled rental place for example. The predetermined period including the scheduled rental date and time can be set as desired to a period from 15 minutes before the scheduled rental time to 15 minutes after the scheduled rental time or a period from 30 minutes before the scheduled rental time to 30 minutes after the scheduled rental time, for example.

The generation unit 26 generates recommended information based on the rental place and rental date and time corresponding to the smaller use fee selected by the selection unit 25.

The provision unit 27 sends the use fee specified by the specification unit 24 and the recommended information generated by the generation unit 26 to the information terminal 1. This can provide the user with the use fee and the recommended information.

The use fee and the recommended information can be provided to the user by showing the information for a display of the information terminal 1 kept by the user or by outputting the information from a speaker of the information terminal 1 by voice.

Here, a current location of the user may be added to the fee confirmation request described above. For example, the current location of the user can be identified by using a global positioning system (GPS) receiver installed in the information terminal 1. In this case, the reception unit 23 and the selection unit 25 of the server 2 function as below. Functions of the generation unit 26 and the provision unit 27 are the same as described above, so description thereof is omitted herein.

The reception unit 23 receives the fee confirmation request with the current location of the user added. Based on the fee confirmation request with the current location of the user added, the selection unit 25 selects a use fee smaller than the use fee corresponding to the scheduled rental place and the scheduled rental date and time, out of the use fees corresponding to rental places within a predetermined distance from the current location and rental dates and times within a predetermined period including the scheduled date and time.

The predetermined distance from the current location and the predetermined period including the scheduled rental date and time can be set in the same manner as the predetermined distance from the scheduled rental place and the predetermined period including the scheduled date and time are set as described above.

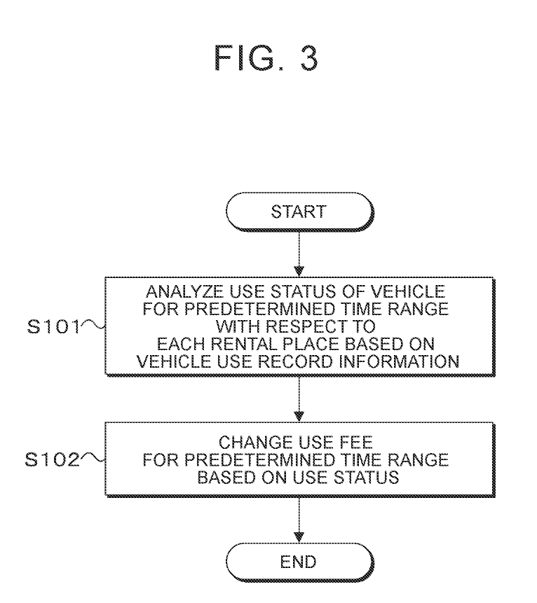

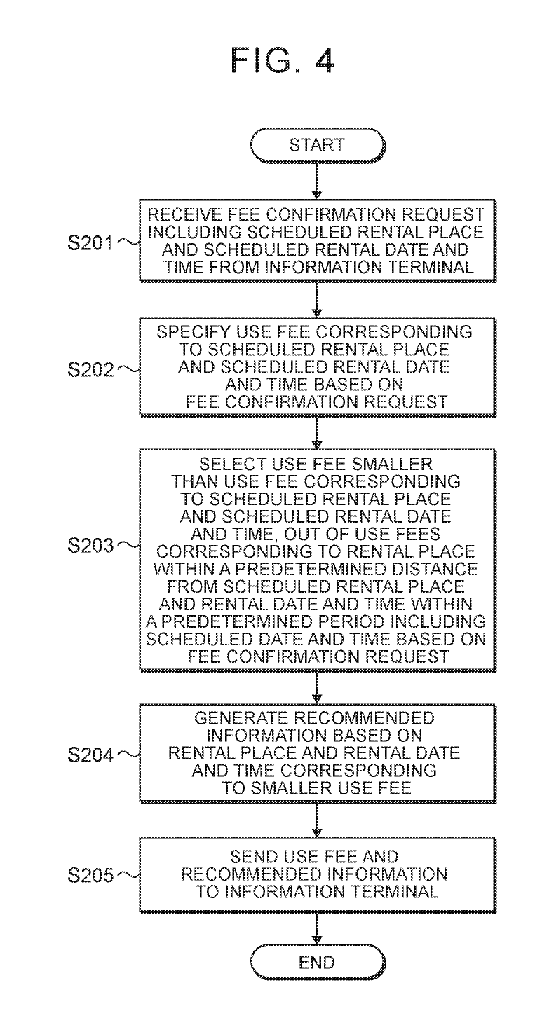

Operations of the server 2 according to the embodiment is described below with reference to FIGS. 3 and 4.

An example of an operation in which the use status of the vehicle is analyzed and the use fee is changed will be described with reference to FIG. 3.

First, the analysis unit 21 of the server 2 analyzes the use status of the vehicle for a predetermined time range with respect to each rental place to rent the vehicle based on the use record information for the vehicles available in the car sharing services (step S101).

Then, the change unit 22 of the server 2 changes the use fee for the predetermined time range (for example, commuting time range, daytime, evening, and early day and late evening) based on the use status (for example, the number of non-operating vehicles) analyzed in step S101 (step S102). The operation is thus completed.

An example of an operation in which the use fee and the recommended information are provided to the user based on the fee confirmation request will he described with reference to FIG. 4.

First, the reception unit 23 of the server 2 receives the fee confirmation request including the scheduled rental place and the scheduled rental date and time input by the user from the information terminal 1 (step S201).

Then, the specification unit 24 of the server 2 specifies the use fee corresponding to the scheduled rental place and the scheduled rental date and time based on the fee confirmation request received in step S201 (step S202).

Subsequently, based on the fee confirmation request received in step S201, the selection unit 25 of the server 2 selects a use fee smaller than the use fee corresponding to the scheduled rental place and the scheduled rental date and time, out of the use fees corresponding to the rental places within the predetermined distance from the scheduled rental place and the rental dates and times within the predetermined period including the scheduled date and time (step S203).

Then, the generation unit 26 of the server 2 generates the recommended information based on the rental place and rental date and time corresponding to the smaller use fee selected in step S203 (step S204).

Subsequently, the provision unit 27 of the server 2 sends the use fee specified in step S202 and the recommended information generated in step S204 to the information terminal 1 (step S205). The operation is thus completed.

As described above, in the vehicle management system 100 according to the embodiment, the server 2 can analyze the use status of the vehicle for a predetermined time range with respect to each rental place to rent the vehicle based on the use record information for the vehicles available in the car sharing services, change the use fee for the predetermined time range based on the analyzed use status, and in the case where the fee confirmation request including the scheduled rental place and the scheduled rental date and time input by the user is received, specify the use fee corresponding to the scheduled rental place and the scheduled rental date and time based on the fee confirmation request, and provide the user with the specified use fee.

This makes it possible to analyze the use status for the rental place of vehicles, change the use fee for the time range in which more vehicles are used to a larger use fee, change the use fee for the time range in which less vehicles are used to a smaller use fee, and provide the user with the use fee corresponding to the scheduled rental place and the scheduled rental date and time input by the user.

Furthermore, in the vehicle management system 100 according to the embodiment, the server 2 can select the use fee smaller than the use fee corresponding to the scheduled rental place and the scheduled rental date and time, out of the use fees corresponding to the rental places within the predetermined distance from the scheduled rental place and the rental dates and times within the predetermined period including the scheduled date and time based on the fee confirmation request, generate the recommended information based on the scheduled rental place and the scheduled rental date and time corresponding to the selected smaller use fee, and provide the user with the recommended information.

This makes it possible to select a smaller use fee out of the use fees corresponding to rental places within the predetermined distance from the scheduled rental place input by the user and the rental dates and times within the predetermined period including the scheduled date and time input by the user, and provide the user with the small use fee as the recommended information, in addition to selecting and providing the user with the use fee corresponding to the scheduled rental place and the scheduled rental time input by the user.

Thus, the vehicle management system 100 according to the embodiment can promote an increase in the operation rate of the vehicles available in car sharing services.

### Modification

The present disclosure is not limited to the embodiment described above and can be implemented in various other forms without departing from the scope of the disclosure. Accordingly, the embodiment described above is merely illustrative in all respects and is not to be construed as restrictive. For example, the respective processing steps described above can be optionally changed in order or executed in parallel as long as there is no inconsistency in processing content.

In the embodiment described above, the recommended information may include a return place and a return date and time designated by an administrator of the vehicle management system 100, and services such as making the use fee free of charge or paying rewards to users that have returned vehicles to the return place before the return time may be provided. Thus the administrator can control a ma distribution status of the vehicles.

The components of the information terminal 1 and the server 2 are not limited to the components of the embodiment described above and any other components can be added appropriately.

What is claimed is:

1. A vehicle management device comprising:
a processor configured to analyze a use status of a vehicle available in a car sharing service for a predetermined time range with respect to each rental place to rent the vehicle based on use record information for the vehicle and change a use fee for the predetermined time range based on the analyzed use status.

2. The vehicle management device according to claim 1, wherein the processor is configured to:
receive a fee confirmation request including a scheduled rental place and a scheduled rental date and time input by a user;
specify the use fee corresponding to the scheduled rental place and the scheduled rental date and time based on the fee confirmation request; and
provide the user with the specified use fee.

3. The vehicle management device according to claim 2, wherein the processor is configured to:
select a use fee smaller than the use fee corresponding to the scheduled rental place and the scheduled rental date and time, out of the use fees corresponding to the rental place within a predetermined distance from the scheduled, rental place and a rental date and time within a predetermined period including the scheduled date and time based on the fee confirmation request;
generate recommended information based on the rental place and rental date and time corresponding to the selected smaller use fee; and
provide the user with the generated recommended information.

4. The vehicle management device according to claim 3, wherein the processor is configured to receive the fee confirmation request further a current location of the including user and select the use fee smaller than the use fee corresponding to the scheduled rental place and the scheduled rental date and time, out of the use fees corresponding to the rental place within the predetermined distance from the scheduled rental place and the rental date and time within the predetermined period including the scheduled date and time based on the fee confirmation request further including the current location of the user.

5. The vehicle management device according to claim 1, wherein the processor is configured to analyze the use status of the vehicle for a day of a week and the predetermined time range with respect to the rental place to rent the vehicle.

6. The vehicle management device according to claim 1, wherein the processor is configured to calculate a transition in the number of non-operating vehicles as the use status.

7. The vehicle management device according to claim 1, wherein the processor is configured to set a larger fee for a time range with a smaller number of non-operating vehicles than a fee set for a time range with a larger number of non-operating vehicles.

8. A vehicle management method executed by a processor, the method comprising:
analyzing a use status of a vehicle available in a car sharing service for a predetermined time range with respect to each rental place to rent the vehicle based on use record information for the vehicle, and
changing a use fee for the predetermined time range based on the analyzed use status.

9. A non-transitory computer-readable medium storing a program that allows a computer to execute processing, wherein the processing includes analyzing a use status of a vehicle available in a car sharing service for a predetermined time range with respect to each rental place to rent the vehicle based on use record information for the vehicle and changing a use fee for the predetermined time range based on the analyzed use status.
